(19) United States
(12) Patent Application Publication
(10) Pub. No.: US 2006/0179111 A1
(43) Pub. Date: Aug. 10, 2006

(54) Data sharing among multiple web sites

(76) Inventor: Steven N. Verona, Margate City, NJ (US)

Correspondence Address: KREMBLAS, FOSTER, PHILLIPS & POLLICK, 7632 SLATE RIDGE BOULEVARD, REYNOLDSBURG, OH, 43068, US

(21) Appl. No.: 11/332,596

(22) Filed: Jan. 12, 2006

Related U.S. Application Data
(60) Provisional application No. 60/644,073, filed on Jan. 14, 2005.

(51) Int. Cl. G06F 15/16; G06F 15/167

(52) U.S. Cl. 709/204; 709/214

(57) ABSTRACT

A method of sharing information among potential dating people that eliminates the need to type the same personal information into every dating web site. Personal data are entered by a user in a main web site, and a linked second dating web site is (and possibly third and more dating web sites are) selected to have access to the data. The user then instructs the main web site to permit the second web site to access the database information, such as by checking a box on the main web site that represents the second web site. A different user can then access the first user's personal information on both web sites, but the first user did not have to enter the same data in multiple dating web sites.

### BACKGROUND OF THE INVENTION

1. Field of the Invention

This invention relates generally to a method of sharing data about users among a plurality of dating internet sites.

2. Description Of The Related Art

In a conventional dating web site, the customer signs up for, or joins, a service by inputting information to the web site about himself or herself, such as age, height, weight, interests, etc. This information makes up the customer's “profile.” If a customer wishes for his or her profile information to be displayed in multiple dating web sites, he or she must enter the information in each and every web site. This is tedious, and because the web sites operate independently, there is a significant monthly subscription charge from each site for being a subscribing customer. Additionally, dating web sites do not share data with one another because they compete with one another.

The need exists for a solution to the problem of entering data in multiple web sites.

### BRIEF SUMMARY OF THE INVENTION

The invention is a plurality of online dating web sites sharing a common database of customer information. With the invention, a customer can create a single information profile on a generic or main web site. The customer may then select one or more topic-specific dating web sites that will also display that customer's profile information without the need to re-enter the data. Because the topic-specific sites share data with the main site, the data need not be entered again.

Examples of topic-specific web sites include sites catering to people in particular geographic regions, divorcees, people of a particular religion or nationality, and many other topics that people might share. With the invention, these topic-specific websites share a common database of information, and are horizontally and vertically integrated. Thus, instead of customers entering their profile information into each and every dating web site, they enter it once into a generic web site, and simply check a box or otherwise instruct the main web site, or any topic-specific dating web sites, that they want their profile information available at the main and/or the topic-specific web site.

The entering of profile information in one database with instructions to post the profile in multiple dating web sites is a significant feature of the invention. Advantages of the invention over the prior art include the elimination of the need for the user to enter redundant profile information for multiple web sites and the fact that efficiency gains for web site operators, in the sharing of the database of information, can be passed on to the customer as reductions in subscription fees.

### BRIEF DESCRIPTION OF THE SEVERAL VIEWS OF THE DRAWINGS

FIG. 1 is a schematic view illustrating a relationship between a main web site and other web sites.

In describing the preferred embodiment of the invention which is illustrated in the drawings, specific terminology will be resorted to for the sake of clarity. However, it is not intended that the invention be limited to the specific term so selected and it is to be understood that each specific term includes all technical equivalents which operate in a similar manner to accomplish a similar purpose. For example, the word connected or term similar thereto are often used. They are not limited to direct connection, but include connection through other elements where such connection is recognized as being equivalent by those skilled in the art.

### DETAILED DESCRIPTION OF THE INVENTION

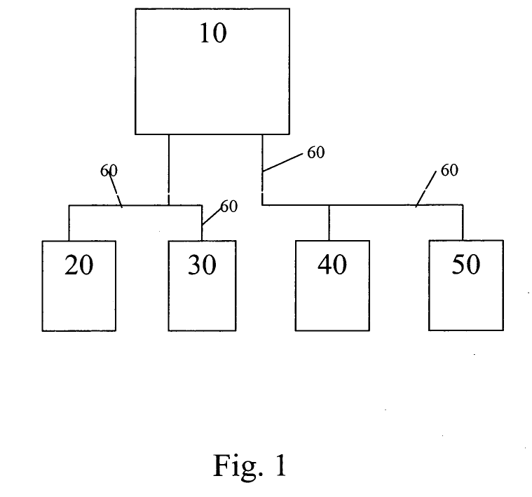

The invention includes the use of a main web site, which is illustrated schematically in FIG. 1 by reference numeral 10 to enter personal information, which is also referred to as data. This information can include the name, age, weight, height and other personal information about a user. The information can include the user's address, photographs, personal preferences (such as culinary, sports, religious and other preferences in a mate or potential spouse), and any other information commonly gathered by those interested in dating.

This data is entered into the main web site 10, such as by typing, using a mouse, or any other conventional data entry means. The user then selects one or more other web sites, such as one of the web sites represented in FIG. 1 by reference numerals 20, 30, 40 and 50. Each of the web sites 20-50 is linked to the main web site 10, which is represented by the lines 60 in FIG. 1. The lines 60 can be conductive wires, such as Ethernet cable or telephone lines, but can also be wireless links between the web sites 20-50 and the main web site 10. Each of the web sites 20-50 is linked to the main web site 10 in a manner that permits communication of the data in the main web site 10 to users of the web sites 20-50.

The data can be made available to the web sites 20-50 by the user who enters the data in the main web site instructing the main web site to “push” the data to one of the web sites 20-50, or it can be by the user instructing one or more of the secondary web sites 20-50 to “pull” the data from the database of the main web site 10. Additionally, there could be a third web site or other platform (such as a kiosk or cell phone) from which the user can instruct the data entered at the main web site 10 to be available to the secondary web sites 20-50.

For example, Joe User can create a profile on “The Dating World”, which serves as a main dating web site. Joe can choose to have his profile data posted on the main dating site (such as at www.thedatingworld.com) as well as a vertical site for people located in a particular region, such as Columbus, Ohio (such as columbusdatingworld.com). Joe can also select a vertical web site for people who make over $100,000 per year (such as wealthydatingworld.com). However, Joe will not have to enter his data at all three sites. Instead, Joe will enter the personal data at one site, and then instruct that site to make the data available to the other sites he selected. Alternatively, Joe could instruct the other two sites to access the data from the main site. Additionally, the number of web sites linked to the data of the main web site will range between one and up to as many as desired, such as hundreds.

It may be desirable for customers to be charged a base fee for use of the generic/main web site, and an additional fee for every vertical web site. However, because of the sharing of the data, the web site operators can charge customers a lower fee for every additional web site compared to an additional full fee for each additional site customers conventionally have to pay when they sign up for multiple web sites, such as Match.com, Yahoo Personals, Date.com, etc.

Joe User can select the vertical dating sites to participate with at any time by simply checking a box or otherwise instructing the web site software through the main/generic site (or alternatively through the vertical sites). Furthermore, it is contemplated that Joe User can have different information available at different sites, or he can make the same information available at all sites. For example, Joe User may wish to remove his picture on a site for people who are “married but looking” and he may choose to have a different description of himself on a site related to his income.

The invention also contemplates the creation of new dating sites, subsequent to the entry of users' profile information at the generic/main web site, in order to meet the ever-changing needs of consumers. This is possible because of the existence of the common database that can be used for any other topic-specific dating web site. This subsequent creation can be combined with an electronic promotion message to encourage registered users to participate in the new dating site. Existing customers could, for example, be given a short trial subscription for free on this new web site in order to encourage use.

The invention also contemplates the creation of “temporary” dating sites, subsequent to the entry of the profile information at the generic web site, in order to meet the ever-changing needs of consumers. These “temporary” sites may be related to current events or any other common interest of the users. For example, during Presidential election time one may want to meet other Republicans for dating or social networking. Once the election has passed the “temporary” site will be closed for lack of continued interest.

While certain preferred embodiments of the present invention have been disclosed in detail, it is to be understood that various modifications may be adopted without departing from the spirit of the invention or scope of the following claims.

1. A method of sharing personal information between potential dates on dating web sites, the method comprising:
(a) a first user entering data about the first user at a first dating web site;
(b) constructing a database of information from at least said data about the first user;
(c) the first user selecting a second dating web site on which said data about the first user will be available and inputting instructions on at least one of said web sites to make the first user's data from the database of information available to other users of the second web site without the first user entering the first user's data in the second web site; and
(d) a second user using the second web site to access the first user's data.

2. The method in accordance with claim 1, further comprising modifying the first user's data for presentation at the second web site.

3. The method in accordance with claim 1, further comprising inputting instructions on at least one of said web sites to make some data unavailable to said second web site.

4. The method in accordance with claim 1, further comprising
(a) the first user selecting a third web site on which said data about the first user will be available;
(b) the first user entering instructions on at least one of said web sites to make the first user's data from the database of information available to other users of the third web site without the first user entering the first user's data in the second web site; and
(c) a third user using the third web site to access the first user's data.

5. The method in accordance with claim 1, further comprising creating a new web site for a topic that is found in the first user's data, and informing users of the main web site about the new web site.
